(19) United States
(12) Patent Application Publication
(10) Pub. No.: US 2018/0223127 A1
(43) Pub. Date: Aug. 9, 2018

(54) ANTI-FINGERPRINGING COMPOSITION WITH SELF-HEALING PROPERTY, FILM, LAMINATE, AND DEVICE

(71) Applicant: SAMSUNG ELECTRONICS CO., LTD., Suwon-si (KR)

(72) Inventors: Chung Kun CHO, Suwon-si (KR); Mikhail KOVALEV, Suwon-si (KR); Nobuji SAKAI, Yokohama-shi (JP); Myung Man KIM, Suwon-si (KR)

(21) Appl. No.: 15/889,607

(22) Filed: Feb. 6, 2018

(30) Foreign Application Priority Data
Feb. 6, 2017 (KR) 10-2017-0016206

(51) Int. Cl. C09D 183/04; C09D 171/00

(52) U.S. Cl. CPC C09D 183/04; C09D 171/00

(57) ABSTRACT

An anti-fingerprinting composition having a self-healing property includes a polyrotaxane, a polyhedral silsesquioxane, and a fluorinated (meth)acryl compound.

### CROSS-REFERENCE TO RELATED APPLICATION

This application claims priority to and the benefit of Korean Patent Application No. 10-2017-0016206, filed in the Korean Intellectual Property Office on Feb. 6, 2017, and all the benefits accruing therefrom under 35 U.S.C. § 119, the content of which in its entirety is herein incorporated by reference.

### BACKGROUND

### 1. Field

An anti-fingerprinting composition having a self-healing property, and a film, a laminate, and a device including the anti-fingerprinting composition are disclosed.

### 2. Description of the Related Art

A thin and light display material and use of a portable electronic device such as a smart phone or a tablet PC are increasingly in demand. A tempered glass or a hard coating film has been used to protect a surface of a device such a display, but these materials are easily broken or scratched by an external impact and it is difficult to recover the material to its original state after being scratched by the external stress. The tempered glass and hard coating film also have a low flexibility, so they are hardly applicable to a flexible device.

Accordingly, there is a need for a protective material having improved properties and which can be applied to an electronic device, in particular, a foldable electronic device.

### SUMMARY

Provided is an anti-fingerprinting composition and a film including the anti-fingerprinting composition having a low friction coefficient with excellent slip properties, excellent water repellency, and high hardness and transparency. The film it may be self-healed after being scratched and has excellent flexibility and thus may be applied to a flexible device and the like. A laminate including the film and a device including the same are provided.

In an embodiment, an anti-fingerprinting composition having a self-healing property includes a polyrotaxane, a polyhedral silsesquioxane, and a fluorinated (meth)acryl compound.

The polyrotaxane may be a compound including a cyclic molecule, a linear molecule penetrating a ring of the cyclic molecule, and a capping group at each terminal end of the linear molecule.

The cyclic molecule may be a cyclodextrin compound having a curable functional group including a (meth)acryl group, a vinyl group, a hydroxy group, a cyanate group, a thiol group, or a combination thereof.

The linear molecule may include polyethylene glycol, polyisoprene, polyisobutylene, polybutadiene, polypropylene glycol, polytetrahydrofuran, polydimethylsiloxane, polyethylene, polypropylene, or a combination thereof.

The capping group may include a dinitrophenyl, a cyclodextrin, an adamantane, a trityl, a fluorescein, a pyrene, a benzene, a polynuclear aromatic, a steroid, or a combination thereof.

The polyhedral silsesquioxane may be substituted with an alkyl group, an aryl group, a (meth)acryl group, a vinyl group, an amino group, an alcohol group, a carboxyl group, a halogen group, or a combination thereof.

The polyhedral silsesquioxane may include a polyhedral silsesquioxane substituted with a phenyl group, a polyhedral silsesquioxane substituted with a (meth)acryl group, a polyhedral silsesquioxane substituted with a halogen group, or a combination thereof.

The fluorinated (meth)acryl compound may include a cyclic siloxane unit and may be a perfluoroether compound having two or more (meth)acryl groups.

The anti-fingerprinting composition having a self-healing property may further include a hardener and a solvent.

The polyrotaxane may be present in an amount of about 15 weight percent (wt %) to about 70 wt % based on a total solid content of the composition.

The polyhedral silsesquioxane may be present in an amount of about 25 wt % to about 80 wt % based on a total solid content of the anti-fingerprinting composition.

The fluorinated (meth)acryl compound may be present in an amount of about 0.1 wt % to about 10 wt % based on a total solid content of the anti-fingerprinting composition.

In an embodiment, a self-healing anti-fingerprinting film includes a cured product of the anti-fingerprinting composition having a self-healing property.

The self-healing anti-fingerprinting film may have a thickness of about 0.01 micrometer (μm) to about 50 μm.

The self-healing anti-fingerprinting film may have a friction coefficient of about 0.01 to about 0.5, a pencil hardness of greater than or equal to about 2H, and a water contact angle of about 100 degrees to about 120 degrees.

The self-healing anti-fingerprinting film may have a light transmittance of greater than or equal to about 80%, a yellowness of less than or equal to about 3, and a haze of less than or equal to about 3%.

In an embodiment, a laminate includes a substrate film, and the self-healing anti-fingerprinting film on at least one surface of the substrate film.

The substrate film may be a self-healing film including a polyurethane compound, a polysiloxane compound, or a combination thereof.

The substrate film may have a thickness of about 10 μm to about 300 μm.

In an embodiment, a device includes the laminate.

The anti-fingerprinting composition having a self-healing property, and similarly the film and the laminate including the anti-fingerprinting composition according to an embodiment, have a low friction coefficient, an excellent slip property, excellent water repellency, high hardness and transparency, may be self-healed after being scratched, and may have excellent flexibility, and so are applicable for a flexible device or the like.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a schematic view showing a cross-section of a laminate according to an embodiment;

FIG. 2 is a schematic view showing a folded shape of a laminate according to an embodiment; and

FIG. 3 is a schematic perspective view showing a folded shape of a foldable display according to an embodiment.

### DETAILED DESCRIPTION

Hereinafter, example embodiments will hereinafter be described in detail, and may be easily realized by a person skilled in the art. However, this disclosure may be embodied in many different forms and is not to be construed as limited to the example embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±20%, 10%, or 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, unless otherwise indicated, “a combination thereof” refers to a combination of at least two components, wherein the combination is in the form of a mixture, a laminate, a composite, a copolymer, an alloy, a blend, a reaction product, etc. of the recited constituents.

A “(meth)acrylate” refers to a methacrylate group and/or an acrylate group. A “(meth)acryl” compound refers to a compound containing a methacryl group and/or an acryl group.

An “alkyl” refers to a straight or branched chain saturated, monovalent hydrocarbon group, for example a C1 to C20 alkyl, a C1 to 010 alkyl, or a C1 to C6 alkyl, for example a methyl, an ethyl, a propyl, a butyl, a pentyl, a hexyl, and the like.

A “cycloalkyl” means a monovalent group having one or more saturated rings in which all ring members are carbon (e.g., cyclopentyl and cyclohexyl), for example, a cyclopropyl, a cyclobutyl, a cyclopentyl, a cyclohexyl, and the like.

An “aromatic” refers to an organic compound or group including at least one unsaturated cyclic group having delocalized p-orbitals. The term encompasses both an aryl group and a heterocyclic group.

An “aryl” refers to a hydrocarbon group having an aromatic single ring or a fused ring.

A “heterocyclic group” is for example a heteroaryl group and refers to an aryl group including at least one heteroatom selected from N, O, S, and P.

As used herein, the term “self-healing” refers to the ability of a material to heal (e.g., repair) relatively minor damage (e.g., scratches, nicks, cuts, and the like) present in the material.

Many commercially available self-healing protective films have a high tacky (sticky) property and a high coefficient of friction relative to a surface on which they are disposed, so that the self-healing protective films have unfavorable slip properties and insufficient self-healing characteristics. An anti-fingerprinting film is a relatively brittle coating film having a three-dimensional cross-linked structure, and as a result, has a deteriorated flexibility. A scratch is formed in the anti-fingerprinting film when a polymer chain forming the film is cut due to an external stress. Such anti-fingerprinting films rarely demonstrate self-healing characteristics after being scratched, so their application to a device having self-healing characteristics is limited. Thus, it would be advantageous to provide an anti-fingerprinting film having good slip properties instead of the self-healing protective film, or which may be additionally formed on the surface of the self-healing protective film. As used herein, the term “anti-fingerprinting” refers to a material prevents the deposition of fingerprints on a surface.

In an embodiment, an anti-fingerprinting composition having a self-healing property includes a polyrotaxane, a polyhedral silsesquioxane, and a fluorinated (meth)acryl compound. The anti-fingerprinting composition having a self-healing property may be a type of coating agent, which may be applied on a substrate film or a surface of a device in a form of a coating layer or a film.

One example of the anti-fingerprinting composition having a self-healing property may include an ultraviolet (UV) curable composition which is cured by ultraviolet (UV) light. In this case, the anti-fingerprinting composition may have excellent self-healing characteristics and anti-fingerprinting characteristics and may improve the process speed and minimize the yellowness index of the cured product, compared to a thermally-cured composition.

The polyrotaxane refers to a mechanically interlocked polymer architecture consisting of a dumbbell shaped molecule which is threaded through a macrocycle. Specifically, the polyrotaxane may include a cyclic molecule, a linear molecule penetrating a ring of the cyclic molecule, and a capping group at each terminal end of the linear molecule. The polyrotaxane may be flexibly moved when external pressure is applied thereto, and thus provides good flexibility and may be highly stretched. A composition including the polyrotaxane may show excellent self-healing characteristics, flexibility, and appropriate hardness.

In the polyrotaxane, the cyclic molecule may be a cyclic molecule including a hydroxy group and may be for example a cyclodextrin compound, and specifically a compound including α-cyclodextrin, β-cyclodextrin, or γ-cyclodextrin.

Polyrotaxane according to an embodiment may have a curable functional group at the terminal end of the cyclic molecule. For example, the cyclic molecule may be a cyclodextrin compound having a structure in which a portion, or all, of the hydroxyl groups of the cyclodextrin molecule is substituted with a functional group including a curable functional group. The polyrotaxane including the cyclic molecule may have an appropriate hardness and flexibility and so may be applied to the curable film.

The curable functional group may be a functional group that may be cured by a reaction with light (e.g., ultraviolet light). For example, the curable functional group may include a (meth)acryl group, a vinyl group, a hydroxy group, a cyanate group, a thiol group, or a combination thereof. Herein, the (meth)acryl group may be a C1 to C20 (meth)acryl group or a C1 to 010 (meth)acryl group; the ester group may be a 01 to 010 ester group, the carboxyl group may be a 01 to 010 carboxyl group; the alkoxy group may be a 01 to 010 alkoxy group; and the hetero cyclic group may be a C3 to C20 hetero cyclic group. The cyclic molecule may include at least one curable functional group, for example two or more, or six or less, or four or less curable functional groups.

For example, the cyclic molecule may be a cyclodextrin compound having a (meth)acryl group at each terminal end thereof, and in this case, the polyrotaxane is applicable for an ultraviolet (UV) curable film and has excellent hardness and optical properties, and excellent self-healing characteristics.

The curable functional group may be directly substituted in the cyclodextrin structure or may be substituted via a linking group such as a polyalkylene, a polyalkylene glycol or a polycaprolactone, and the like. That is, the cyclic molecule may be a cyclodextrin compound substituted with a polyalkylene having a curable functional group at the terminal end, or a polyalkylene glycol having a curable functional group at the terminal end, or a polycaprolactone having a curable functional group at the terminal end. For example, the cyclic molecule may be cyclodextrin substituted with polycaprolactone having a (meth)acryl group at the terminal end. The polyrotaxane including the cyclic molecule is applicable to a curable film and shows excellent hardness and optical properties, and excellent self-healing characteristics.

In the polyrotaxane, the linear molecule may include for example polyethylene glycol, polyisoprene, polyisobutylene, polybutadiene, polypropylene glycol, polytetrahydrofuran, polydimethylsiloxane, polyethylene, polypropylene, or a combination thereof, and in this case, the polyrotaxane is stable when exposed to ultraviolet (UV) light, and has improved optical properties. A molecular weight of the linear molecule may be greater than or equal to about 10,000 grams per mole (g/mol), or greater than or equal to about 30,000 g/mol and less than or equal to about 500,000 g/mol.

The capping groups are positioned at each of the terminal ends of the linear molecule to prevent the linear molecule from escaping from the cyclic molecule. The capping group may include, for example, a dinitrophenyl, a cyclodextrin, an adamantane, a trityl, a fluorescein, a pyrene, a benzene, a polynuclear aromatic, a steroid, or a combination thereof. The capping group may be substituted with an alkyl group, a hydroxy group, a halogen group, a cyano group, a sulfonyl group, a carboxyl group, an amino group, a phenyl group, or a combination thereof may be substituted, or may be unsubstituted.

A molecular weight of the polyrotaxane according to an embodiment may be greater than or equal to about 100,000 g/mol and less than or equal to about 5,000,000 g/mol, for example greater than or equal to about 500,000 g/mol and less than or equal to about 3,000,000 g/mol, or greater than or equal to about 8000,000 g/mol and less than or equal to about 2,000,000 g/mol. When the polyrotaxane has a molecular weight within the above-described ranges, the composition including the polyrotaxane may have good properties. The molecular weight may be a value analyzed by a gel permeation chromatography (GPC).

The polyrotaxane may have a tensile strain of about 100% to about 1500%, for example, greater than or equal to about 300% or greater than or equal to about 600%. When the polyrotaxane has a tensile strain within the above-described range, the composition and the film including the same may be not easily broken or scratched due to external stress or the like, and may demonstrate excellent self-healing characteristics.

The polyrotaxane may be present in an amount of about 15 wt % to about 70 wt %, for example, about 25 wt % to about 60 wt %, or about 30 wt % to about 50 wt % based on the total weight of the polyrotaxane, the polyhedral silsesquioxane, and the fluorinated (meth)acryl compound in the anti-fingerprinting composition. In this case, the film including the anti-fingerprinting composition and the cured product thereof may have excellent properties such as a slip property, hardness, water repellency, self-healing, and transparency.

The polyhedral silsesquioxane according to an embodiment is an organic silicon compound, and may be also referred to as polyhedral oligomeric silsesquioxane (hereinafter POSS). The POSS may be substituted or unsubstituted. A type of the POSS is not particularly limited, and may be for example POSS substituted with an alkyl group, an aryl group, a (meth)acryl group, a vinyl group, an amino group, an alcohol group, a carboxyl group, a halogen group, or a combination thereof.

The POSS substituted with an alkyl group may be for example octamethyl POSS, octaethyl POSS, octaisobutyl POSS, octaisooctyl POSS, trifluoropropyl POSS, and the like. The POSS substituted with an aryl group may be for example, octaphenyl POSS, dodecaphenyl POSS, trisilanolphenyl POSS, tetrasilanolphenyl POSS, aminopropylphenyl POSS, phenylisobutyl POSS, and the like. The POSS substituted with a (meth)acryl group may be for example (meth)acrylo POSS, (meth)acrylpropyl POSS, (meth)acrylisobutyl POSS, (meth)acrylisooctyl POSS, and the like. The halogen group may be fluorine, chlorine, bromine, iodine, and the like, and a POSS substituted with a halogen group may be a POSS directly substituted with a halogen group or may be a POSS substituted with an alkyl halide group, an aryl halide group, a (meth)acryl halide group. For example, an alkyl fluoride POSS, for example propyl fluoride POSS may be used. A combination comprising at least one of the foregoing POSS may also be used.

In an embodiment, the polyhedral silsesquioxane may include a polyhedral silsesquioxane substituted with a phenyl group, a polyhedral silsesquioxane substituted with a (meth)acryl group, a polyhedral silsesquioxane substituted with a halogen group, or a combination thereof. For example, the polyhedral silsesquioxane substituted with a phenyl group may be present in an amount of about 0% to about 60% or about 10 to about 60%, the polyhedral silsesquioxane substituted with a (meth)acryl group may be included in an amount of about 30% to about 99% or about 40% to about 85%, and the polyhedral silsesquioxane substituted with a halogen group may be included in an amount of about 0% to about 10% or about 0.1% to about 5%, wherein the amount is based on a total weight of the polyhedral silsesquioxane. In this case, a composition and a film including the same have improved hardness and may show good optical properties and self-healing characteristics.

The polyhedral silsesquioxane may be present in an amount of about 25 wt % to about 80 wt %, for example, about 35 wt % to about 70 wt %, or about 40 wt % to about 70 wt % based on the total weight of the polyrotaxane, the polyhedral silsesquioxane, and the fluorinated (meth)acryl compound. In this case, the film including the anti-fingerprinting composition and the cured product thereof may have an excellent slip property and hardness, and also may have excellent properties such as water repellency, self-healing, and transparency.

The fluorinated (meth)acryl compound may be a compound including at least one (meth)acryl group, for example, a compound having greater than or equal to about 2, or greater than or equal to about 3 (meth)acryl groups, the number of which is appropriately applicable for a cross-linkable and curable composition. Preferably the fluorinated (meth)acryl compound is a fluorinated acryl compound. In addition, the fluorinated (meth)acryl compound may be, for example, a perfluoroether compound having at least one (meth)acryl group, for example, a compound in which a (meth)acryl group, preferably an acryl group, is bound directly or via other functional group to both terminal ends of a perfluoroether portion. In this case, the composition and the film including the same may have an excellent slip property and water repellency or the like. In this case, the perfluoroether moiety may have a molecular weight of about 500 g/mol to about 30,000 g/mol.

In addition, the fluorinated (meth)acryl compound may include a siloxane unit. In this case, the fluorinated (meth)acryl compound may be well mixed with the polyhedral silsesquioxane, and may improve properties such as hardness and transparency of the compound including the same. The siloxane unit may be a cyclic siloxane unit derived from tetramethyl cyclotetrasiloxane, pentamethyl cyclopentasiloxane, or the like.

For example, the fluorinated (meth)acryl compound may be a perfluoroether compound including a (meth)acryl group and a siloxane unit, for example, a compound having a structure in which the cyclic siloxane units are positioned at the terminal ends of perfluoroether, and the (meth)acryl group is bound to both of the siloxane units. In this case, the composition and the film including the same may have an excellent slip property and water repellency and may also possess excellent properties such as self-healing characteristics and optical properties.

The fluorinated (meth)acryl compound may be present in an amount of about 0.1 wt % to about 10 wt %, for example, about 0.1 wt % to about 8 wt %, or about 0.1 wt % to about 5 wt % based on the total weight of the polyrotaxane, the polyhedral silsesquioxane, and the fluorinated (meth)acryl compound. In this case, the composition and the film including the cured product thereof may have improved slip property and hardness and also may possess excellent properties such as water repellency, self-healing property, and transparency.

The anti-fingerprinting composition having a self-healing property may further include a hardener and a solvent.

The hardener may be, for example, a photoinitiator. The photoinitiator may be a free radical photoinitiator, an ionic photoinitiator, or a combination thereof. For example, the photoinitiator may be a benzophenone, a ketone initiator, a benzoic acid, an anthraquinone, an acyl phosphine, or the like, but is not limited thereto.

Specific examples of the hardener may include an acetophenone such as diethoxyacetophenone, 2-hydroxy-2-methyl-1-phenylpropan-1-one, benzyldimethyl ketal, 1-hydroxycyclohexyl-phenyl ketone, 2-methyl-2-morphine (4-thiomethylphenyl)propan-1-one, or the like; a benzoinether such as benzoinmethylether, benzoinethylether, benzoinisopropylether, benzoinisobutylether, or the like; a benzophenone such as benzophenone, methyl o-benzoyl benzoate, 4-phenylbenzophenone, 4-benzoyl-4′-methyldiphenylsulfurous acid, 4-benzoyl-N,N-dimethyl-N-[2-(1-oxo-2-propenyloxy)ethyl] benzenemethanaminium bromide, (4-benzoylbenzyl)trimethylammonium chloride, or the like; a thioxanthone such as 2,4-diethylthioxanthone, 1-chloro-4-dichlorothioxanthone, or the like; 2,4,6-trimethylbenzoyldiphenylbenzoyloxide, or the like. The hardener may be used alone or as a combination thereof.

The hardener may be present in an amount of about 0.01 wt % to about 5 wt %, for example about 0.1 wt % to about 3 wt % based on a total solid content of the anti-fingerprinting composition having a self-healing property. When the hardener is included within the above-described ranges, a cured product having good properties may be obtained.

The solvent used in the anti-fingerprinting composition is not limited as long as it is able to dissolve or disperse the aforementioned components. The solvent may include, for example, at least one of an aliphatic hydrocarbon solvent such as hexane, heptane, methylene chloride, or the like; an aromatic hydrocarbon solvent such as benzene, toluene, pyridine, quinoline, anisole, mesitylene(mesitylene), xylene, or the like; a ketone solvent such as methyl isobutyl ketone, 1-methyl-2-pyrrolidinone (NMP), cyclohexanone, acetone, or the like; an ether solvent such as tetrahydrofuran (THF), isopropyl ether, or the like; an acetate solvent such as ethyl acetate, butyl acetate, propylene glycol methyl ether acetate, or the like; an alcohol solvent such as isopropyl alcohol, butanol, or the like; an amide solvent such as dimethyl acetamide, dimethylformamide (DMF), or the like; a nitrile solvent such as acetonitrile, benzonitrile, or the like. A combination comprising at least one of the foregoing solvents may also be used.

In an anti-fingerprinting composition having a self-healing property including the polyrotaxane, the polyhedral silsesquioxane, the fluorinated (meth)acryl compound, the hardener, and the solvent, the polyrotaxane may be present in an amount of about 15 wt % to about 70 wt %, or about 15 wt % to about 60 wt %, or about 25 wt % to about 60 wt %, or about 30 wt % to about 50 wt %; the polyhedral silsesquioxane may be present in an amount of about 25 wt % to about 80 wt %, or about 35 wt % to about 70 wt %, or about 40 wt % to about 70 wt %, or about 50 wt % to about 70 wt %; and the fluorinated (meth)acryl compound may be present in an amount of about 0.1 wt % to about 10 wt %, about 0.1 wt % to about 8 wt %, or about 0.1 wt % to about 5 wt % based on a total solid content of the anti-fingerprinting composition. When each of the components is included within the above-described ranges, the anti-fingerprinting composition may have excellent properties such as a slip property, hardness, water repellency, self-healing property, and transparency.

An embodiment provides a self-healing anti-fingerprinting film including a cured product of the anti-fingerprinting composition having a self-healing property. The anti-fingerprinting composition having a self-healing property is coated on a substrate film or a surface of a device and cured to provide a self-healing anti-fingerprinting film. The self-healing anti-fingerprinting film may be a coating film or a coating layer, for example, a coating film for protecting a window for a display device.

An embodiment provides a laminate including a substrate film and the self-healing anti-fingerprinting film positioned on at least one surface of the substrate film, for example, on one or both surfaces of the substrate film. The laminate may be a laminated film for protecting a surface of a device, for example, a laminated film for protecting a display module of a display. The laminate may have a structure in which the substrate film and the self-healing anti-fingerprinting film are sequentially stacked on the device surface, so that the self-healing anti-fingerprinting film is positioned on the outermost surface.

Since the laminate is colorless, has sufficient transparency to provide excellent optical properties, and demonstrates self-healing characteristics (that is, healed by itself after being scratched), and has a high hardness and excellent flexibility, the laminate may be appropriately used as a coating film for a foldable, bendable, or rollable display, or the like. The self-healing anti-fingerprinting film has a surface having an excellent slip property and a water repellency which are sufficient to suppress the phenomenon of staining the film with fingerprints.

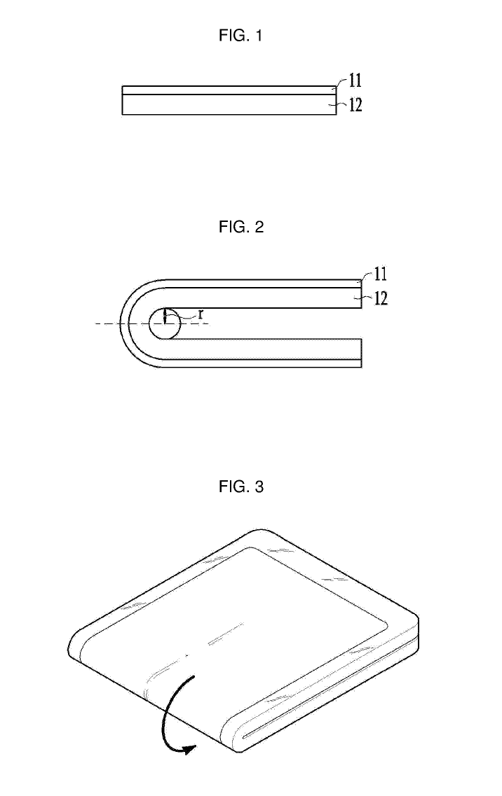

FIG. 1 is a schematic view showing a cross-section of a laminate according to an embodiment, and FIG. 2 is a schematic view showing a folded shape of a laminate. In FIGS. 1 and 2, the reference numeral 11 indicates the self-healing anti-fingerprinting film and a reference numeral 12 indicates a substrate film, and in FIG. 2, r indicates a curvature radius of the folded laminate.

In the laminate, the substrate film may consist essentially of, or may consist of a transparent polymer. The transparent polymer may be, for example, a polyester such as polyethylene terephthalate, or the like, a polycarbonate, a polyolefin, a polyimide, a polyamide, or a combination thereof. Alternatively, the substrate film may be a self-healing substrate film having a high flexibility and capable healing itself when scratched. The substrate film may include any commercially available self-healing substrate films without limit, for example, a self-healing substrate film including a polyurethane compound, a polysiloxane compound, or a combination thereof.

The self-healing anti-fingerprinting film has flexibility and self-healing characteristics, and is able to prevent a fingerprint stain and to heal itself when is coated on the commercially available self-healing substrate film.

A commercially available self-healing substrate film has a high tacking property and a high friction coefficient at the surface thereof, so the slip property and the water repellency are often unfavorable. On the other hand, the laminate described herein according to an embodiment has a structure in which the self-healing anti-fingerprinting film is coated on the self-healing substrate film, so it may improve the slip property and water repellency thereof and also provide anti-fingerprinting properties, and may further improve self-healing characteristics of the substrate film.

The polyurethane compound and the polysiloxane compound are not limited, and may include any one of these types of compounds which possess self-healing characteristics without limit. One example of the polyurethane compound may include a polyurethane compound obtained from a diisocyanate compound and an alcohol compound, specifically, the polyurethane may be a urethane(meth)acrylate compound having at least one (meth)acryl group at a terminal end thereof. The urethane(meth)acrylate compound may be synthesized according to any suitable method, for example, may be synthesized by preparing a polyurethane from a diol compound having two hydroxy groups and a diisocyanate compound having two isocyanate groups and reacting the same with (meth)acrylate having a hydroxy group.

For example, the urethane(meth)acrylate may be a compound having a total of two (meth)acryl groups, one at each terminal end, and at least 6 urethane groups between the (meth)acryl groups. The urethane(meth)acrylate having this structure shows excellent self-healing characteristics and a high flexibility and so is appropriately applicable to a flexible device. One example of the urethane(meth)acrylate includes a compound having greater than or equal to about 6, greater than or equal to about 8, or less than or equal to about 12 urethane groups.

The substrate film may have a thickness of about 10 μm to about 300 μm, for example about 40 μm to about 200 μm, or about 50 μm to about 100 μm. In addition, the self-healing anti-fingerprinting film may have a thickness of about 0.01 μm to about 50 μm, for example about 0.01 μm to about 30 μm, or about 0.1 μm to about 20 μm, or about 0.1 μm to about 10 μm. The self-healing anti-fingerprinting film may be thinner than the substrate film. When the substrate film and the self-healing anti-fingerprinting film have a thickness within the above-described ranges, the laminate including the same may have excellent properties such as a self-healing characteristic, a slip property, water repellency, hardness, and optical properties, and may also have a high flexibility.

In the laminate, the surface of the self-healing anti-fingerprinting film may have an excellent slip property, specifically, a very low friction coefficient. The friction coefficient may be measured using a friction tester (e.g., LABTHINK®, FPT-F1 Friction/Peel Tester) in accordance with ASTM D1894. For example, the self-healing anti-fingerprinting film may have a friction coefficient at its surface of less than or equal to about 0.5, or less than or equal to about 0.3, for example, about 0.01 to about 0.5, about 0.01 to about 0.4, about 0.01 to about 0.3, or about 0.1 to about 0.2. The friction coefficient includes a static friction coefficient and a kinetic friction coefficient, and these two types of friction coefficients may each independently fall within the above-described ranges.

The self-healing anti-fingerprinting film and the laminate including the same may have a high hardness, for example, a pencil hardness of greater than or equal to about 2H, greater than or equal to about 4H, or greater than or equal to about 6H.

The pencil hardness may be measured using a pencil hardness tester (e.g., an automatic pencil hardness tester, No. 553-M1, manufactured by Yasda Seiki) and a pencil manufactured by Mitsubishi, and in accordance with the ASTM D3363 standard. For example, the laminate is fixed on a glass plate having a thickness of 2 mm, and then a pencil is moved across a surface of the laminate for a distance of 10 mm, at a speed of 60 mm/min, 5 times under a vertical load of 1 kilogram (kg). The pencil having the greatest level of hardness at which the surface of the laminate is not scratched, is considered to be the pencil hardness of the laminate.

The self-healing anti-fingerprinting film and the laminate including the same may show excellent self-healing characteristics. For example, when the self-healing anti-fingerprinting film is scratched on the surface with a pencil having a hardness of 4H, the healing time is less than or equal to about 24 hours, or less than or equal to about 12 hours, or less than or equal to about 6 hours.

In addition, if a permanent pen is used to draw on the surface of the self-healing anti-fingerprinting film, which is a type of a marker test, it may be smoothly drawn and removed from a surface thereof without causing any scratches, so it is appropriately applicable for a protective film of a surface of the various devices including an electronic device such as a smart phone.

In addition, the surface of the self-healing anti-fingerprinting film may have excellent water repellency, specifically, a high water contact angle. For example, the surface of the self-healing anti-fingerprinting film may have a water contact angle of greater than or equal to about 100 degrees, greater than or equal to about 105 degrees, greater than or equal to about 110 degrees, or less than or equal to about 120 degrees. The water contact angle may be evaluated according to a Sessile drop technique, for example, the water contact angle may be determined by dripping water on the surface of the film and measuring the contact angle using a contact angle tester (e.g., drop shape analyzer; DSA100, manufactured by KRUSS, Germany).

The self-healing anti-fingerprinting film, in itself, or the laminate including the same, may show excellent optical properties. For example, the self-healing anti-fingerprinting film and the laminate including the same may have a light transmittance of greater than or equal to about 80%, for example, greater than or equal to about 90%; a yellowness index of less than or equal to about 3 or less than or equal to about 1; and a haze of less than or equal to about 3% or less than or equal to about 1%. The light transmittance, the yellowness index, and the haze may be measured using an ultraviolet (UV) spectrophotometer (cm-3600d, manufactured by KONICA MINOLTA) in accordance with the ASTM E313 standard.

In an embodiment, a device includes the self-healing anti-fingerprinting film or the laminate. The device may be any device having an exterior material in need of self-healing characteristics and slipping properties. For example, the device may be an electronic device such as a smart phone, a tablet PC, a camera, a touch screen panel, and the like, a home appliance, an interior or exterior material for a vehicle, an electronic member, various types of plastic molded articles, and the like. In addition, the device may be a flexible device such as a foldable, bendable, or rollable device, and examples thereof may include a foldable display or a foldable smart phone.

The laminate may be applied on, for example, a display panel attached to a window. A substrate film is formed on the window surface of the display panel, and then a solution including the anti-fingerprinting composition with a self-healing property is coated thereon and cured to provide a film. Alternatively, the laminate film may be attached onto the window surface of the display panel. In this case, an adhesive layer or a transparent substrate layer may be present between the device and the laminate, and another protective layer or another coating layer may be present on the outer surface of the laminate.

The laminate may effectively prevent the device from physical and/or chemical damage, and may be self-healed after being scratched, so it may effectively protect the device for a long time. In addition since the laminate is both colorless and transparent, it does not influence the appearance of the device. In addition, the laminate may have a good slip property and water repellency which is sufficient to suppress the phenomenon of staining of the surface thereof with fingerprints and to show anti-fouling characteristics. The laminate also has a high flexibility, so it may safely protect the device even if the device is folded and unfolded tens of thousands of times.

FIG. 3 is a schematic perspective view showing a folded shape of a foldable display according to an embodiment. The foldable display shown in FIG. 3 may be an outwardly foldable display in which a display module is unfolded toward the outside. According to an embodiment, the self-healing anti-fingerprinting film or the laminate may be positioned on a surface of an external display module of the foldable display.

Hereinafter, the embodiments are illustrated in more detail with reference to examples. However, these examples are exemplary, and the present disclosure is not limited thereto.

### EXAMPLES

### Example and Comparative Example: Preparation of Anti-Fingerprinting Composition with Self-Healing Property

### Example 1

59 wt % of polyrotaxane (Advanced Softmaterials) including a cyclodextrin cyclic molecule in which a polycaprolactone functional group having a methacrylate group at a terminal end is substituted, a polyethylene glycol linear molecule penetrating a ring of the cyclic molecule, and adamantane capping groups at both ends of the linear molecule and having a molecular weight of about 1,000,000 g/mol, 39 wt % of acryl POSS (Hybrid Plastic), 1 wt % of fluorinated propyl POSS (Hybrid Plastic), and 1 wt % of fluorinated acryl compound (ShinEtsu, KY-1203) are mixed together to provide an anti-fingerprinting composition having a self-healing property.

### Example 2

An anti-fingerprinting composition having a self-healing property is prepared in accordance with the same procedure as described in Example 1, except that 49 wt % of polyrotaxane, 39 wt % of acryl POSS, 1 wt % of fluorinated propyl POSS, and 11 wt % of trisilanolphenyl POSS (Hybrid Plastic) are used.

### Example 3

An anti-fingerprinting composition having a self-healing property is prepared in accordance with the same procedure as in Example 1, except that 40 wt % of polyrotaxane, 38 wt % of acryl POSS, 1 wt % of fluorinated propyl POSS, and 20 wt % of trisilanolphenyl POSS are used.

### Example 4

An anti-fingerprinting composition having a self-healing property is prepared in accordance with the same procedure as in Example 1, except that 30 wt % of polyrotaxane is used, and 38 wt % of acryl POSS, 1 wt % of fluorinated propyl POSS, and 30 wt % of trisilanolphenyl POSS are used.

### Example 5

An anti-fingerprinting composition having a self-healing property is prepared in accordance with the same procedure as in Example 1, except that 20 wt % of polyrotaxane is used, and 38 wt % of acryl POSS, 1 wt % of fluorinated propyl POSS, and 40 wt % of trisilanolphenyl POSS are used.

### Example 6

An anti-fingerprinting composition having a self-healing property is prepared in accordance with the same procedure as in Example 1, except that 38 wt % of polyrotaxane is used, and 38 wt % of acryl POSS, 1 wt % of fluorinated propyl POSS, and 20 wt % of trisilanolphenyl POSS, and 3 wt % of fluorinated acryl compound are used.

### Example 7

An anti-fingerprinting composition having a self-healing property is prepared in accordance with the same procedure as in Example 1, except that 36 wt % of polyrotaxane is used, and 38 wt % of acryl POSS, 1 wt % of fluorinated propyl POSS, and 20 wt % of trisilanolphenyl POSS, and 5 wt % of fluorinated acryl compound are used.

### Example 8

An anti-fingerprinting composition having a self-healing property is prepared in accordance with the same procedure as in Example 1, except that 31 wt % of polyrotaxane is used, and 38 wt % of acryl POSS, 1 wt % of fluorinated propyl POSS, and 20 wt % of trisilanolphenyl POSS are used, and 10 wt % of fluorinated acryl compound are used.

### Example 9

An anti-fingerprinting composition having a self-healing property is prepared in accordance with the same procedure as in Example 1, except that 40 wt % of polyrotaxane, 39 wt % of acryl POSS, and 20 wt % of trisilanolphenyl POSS are used, and 1 wt % of fluorinated acryl compound is used.

### Example 10

An anti-fingerprinting composition having a self-healing property is prepared in accordance with the same procedure as in Example 1, except that 40 wt % of polyrotaxane, 49 wt % of acryl POSS, and 10 wt % of trisilanolphenyl POSS, and 1 wt % of fluorinated acryl compound are used.

### Example 11

An anti-fingerprinting composition having a self-healing property is prepared in accordance with the same procedure as in Example 1, except that 40 wt % of polyrotaxane, 59 wt % of acryl POSS, and 1 wt % of fluorinated acryl compound are used.

### Comparative Example 1

An anti-fingerprinting composition having a self-healing property is prepared in accordance with the same procedure as in Example 1, except that 99 wt % of polyrotaxane and 1 wt % of fluorinated acryl compound are used, but POSS is not used.

### Comparative Example 2

An anti-fingerprinting composition having a self-healing property is prepared in accordance with the same procedure as in Example 1, except that 41 wt % of polyrotaxane, 38 wt % of acryl POSS, 1 wt % of fluorinated propyl POSS, and 20 wt % of trisilanolphenyl POSS are used, but the fluorinated acryl compound is not used.

The amount of each of the components in the compositions obtained from Examples 1 to 11 and Comparative Examples 1 and 2 is shown in Table 1:

TABLE 1

| | | Fluorinated | | | | |
|---|---|---|---|---|---|---|
| | | acryl | POSS (wt %) | | | |
| | Polyrotaxane | compound | Phenyl | Acryl | Fluorinated | Total amount of |
| | (wt %) | (wt %) | POSS | POSS | POSS | POSS (wt %) |
| Example 1 | 59 | 1 | 0 | 39 | 1 | 40 |
| Example 2 | 49 | 1 | 10 | 39 | 1 | 50 |
| Example 3 | 40 | 1 | 20 | 38 | 1 | 59 |
| Example 4 | 30 | 1 | 30 | 38 | 1 | 69 |
| Example 5 | 20 | 1 | 40 | 38 | 1 | 79 |
| Example 6 | 38 | 3 | 20 | 38 | 1 | 59 |
| Example 7 | 36 | 5 | 20 | 38 | 1 | 59 |
| Example 8 | 31 | 10 | 20 | 38 | 1 | 59 |
| Example 9 | 40 | 1 | 20 | 39 | 0 | 59 |
| Example 10 | 40 | 1 | 10 | 49 | 0 | 59 |
| Example 11 | 40 | 1 | 0 | 59 | 0 | 59 |
| Comparative | 99 | 1 | 0 | 0 | 0 | 0 |
| Example 1 | | | | | | |
| Comparative | 41 | 0 | 20 | 38 | 1 | 59 |
| Example 2 | | | | | | |

### Preparation Example and Comparative Preparation Example: Manufacture of Film Laminate

### Preparation Example 1

Isophorone diisocyanate, polycaprolactone diol, and hydroxypropyl acrylate are reacted at a mole ratio of 3:2:2 to provide a urethane acrylate having a structure including six urethane groups between an acryl group at each of the terminal ends. The urethane acrylate, 1 wt % of trisilanolphenyl POSS and 0.5 wt % of photoinitiator (Irgacure 184) are mixed with an ethyl acetate solvent to provide a self-healing composition. The amounts of POSS and photoinitiator are based on the total weight of the solids. The obtained self-healing composition is dried at 80° C. for about 10 minutes and photocured by irradiating with ultraviolet (UV) light for 3 seconds to provide a self-healing substrate film having a thickness of about 70 μm.

Isophorone diisocyanate, polycaprolactone diol, and hydroxypropyl acrylate are reacted at a mole ratio of 4:3:2 to provide urethane acrylate having a structure including 8 urethane groups between the terminal acryl groups; and the urethane acrylate and 1 wt % of trisilanolphenyl POSS and 0.5 wt % of photoinitiator (Irgacure 184) are mixed with the ethyl acetate solvent to provide a self-healing composition; and the self-healing composition is coated on the film and dried at 80° C. for about 10 minutes and photocured by irradiating ultraviolet (UV) light for 2 minutes to provide a self-healing laminated film having a thickness of about 80 μm, so as to prepare a self-healing substrate film having a total thickness of 150 μm. The anti-fingerprinting composition having a self-healing property obtained from Example 1 is coated on the surface of the obtained self-healing substrate film and dried at 120° C. for about 1 minute and then photocured by radiating ultraviolet (UV) light for 2 minutes under a nitrogen atmosphere to provide a self-healing anti-fingerprinting film having a thickness of about 1 μm, so as to finally to provide a laminate formed with the self-healing anti-fingerprinting film on the self-healing substrate film.

### Preparation Examples 2 to 11

A laminate is fabricated in accordance with the same procedure as in Preparation Example 1, except that the compositions according to Examples 2 to 11 are used, respectively, instead of the anti-fingerprinting composition having a self-healing property according to Example 1.

### Comparative Preparation Example 1

A self-healing substrate film according to Preparation Example 1 is prepared without employing the self-healing anti-fingerprinting film.

### Comparative Preparation Examples 2 and 3

A laminate is fabricated in accordance with the same procedure as in Preparation Example 1, except that the compositions according to Comparative Example 1 and Comparative Example 2 are used instead of the anti-fingerprinting composition having a self-healing property according to Example 1.

### Evaluation Example 1: Friction Coefficient

The laminates according to Preparation Examples 1 to 11 and Comparative Preparation Examples 1 to 3 are measured for a friction coefficient of the surface of the self-healing anti-fingerprinting film, and the results are shown in Table 2. The friction coefficient is measured using a friction measuring device (LABTHINK®, FPT-F1).

### Evaluation Example 2: Pencil Hardness

The laminates according to Preparation Examples 1 to 11 and Comparative Preparation Examples 1 to 3 are measured for a pencil hardness of the surface of the self-healing anti-fingerprinting film, and the results are shown in Table 2. The pencil hardness is obtained using a pencil hardness tester (automatic pencil hardness tester No. 553-M1, manufactured by Yasda Seiki) in accordance with the ASTM D3363 standard.

### Evaluation Example 3: Self-Healing Characteristics

When the laminates according to Preparation Examples 1 to 11 and Comparative Preparation Examples 1 to 3 are scratched on the surface of the self-healing anti-fingerprinting film with a pencil having the various pencil hardnesses, the self-healing pencil hardness and the self-healing time are evaluated, and the results are shown in Table 2.

### Evaluation Example 4: Marker Test

The laminates obtained from Preparation Examples 1 to 11 and Comparative Preparation Examples 1 to 3 are marked with a permanent pen on the surface of the self-healing anti-fingerprinting film, and it is evaluated whether the ink trace is easily erased from the surface or not, and the results are shown in Table 2. X indicates that the permanent pen ink is not erased without surface damage; 0 indicates that the permanent pen ink is erased without surface damage.

### Evaluation Example 5: Water Contact Angle

The laminates obtained from Preparation Examples 1 to 11 and Comparative Preparation Examples 1 to 3 are measured for a water contact angle with respect to the surface of the self-healing anti-fingerprinting film, and the results are shown in Table 2. The water contact angle is determined by dripping water onto the film surface and measuring a contact angle using a contact angle measurement device (Drop shape analyzer; DSA100, manufactured by KRUSS, Germany).

### Evaluation Example 6: Optical Properties

The film laminates obtained from Preparation Examples 1 to 11 and Comparative Preparation Examples 1 to 3 are measured for light transmittance, yellowness index, and haze using an infrared ray spectrophotometer (cm-3600d, manufactured by KONICA MINOLTA) in accordance with the ASTM E313 standard. The results show that the light transmittance is greater than or equal to 91%, the yellowness index ranges from 0.1 to 0.6, and the haze ranges from 0.1% to 0.5%, each of which are considered to provide good optical properties.

TABLE 2

| | | Amount of | | | | | | |
|---|---|---|---|---|---|---|---|---|
| | Amount | fluorine | | | | Self- | | Water |
| | of | acryl | Friction | | | healing | | contact |
| | POSS | compound | coefficient | | Pencil | time | Marker | angle |
| | (wt %) | (wt %) | Static | Kinetic | hardness | (hour) | test | (°) |
| Comparative | — | — | 1.6 | 1.1 | <3B | X | X | 76 |
| Preparation | | | | | | | | |
| Example 1 | | | | | | | | |
| Comparative | 0 | 1 | 0.64 | 0.35 | <3B | X | ◯ | 112 |
| Preparation | | | | | | | | |
| Example 2 | | | | | | | | |
| Comparative | 59 | 0 | >2.1 | >2.1 | <3B | X | X | 87 |
| Preparation | | | | | | | | |
| Example 3 | | | | | | | | |
| Preparation | 40 | 1 | 0.17 | 0.17 | 2H | 24 h | ◯ | 113 |
| Example 1 | | | | | | | | |
| Preparation | 50 | 1 | 0.21 | 0.21 | 5H | 24 h | ◯ | 111 |
| Example 2 | | | | | | | | |
| Preparation | 59 | 1 | 0.20 | 0.17 | 6H | 24 h | ◯ | 114 |
| Example 3 | | | | | | | | |
| Preparation | 69 | 1 | 0.18 | 0.18 | 5H | 24 h | ◯ | 111 |
| Example 4 | | | | | | | | |
| Preparation | 79 | 1 | — | — | — | — | — | — |
| Example 5 | | | | | | | | |
| Preparation | 59 | 3 | 0.18 | 0.18 | 9H | 24 h | ◯ | 114 |
| Example 6 | | | | | | | | |
| Preparation | 59 | 5 | 0.19 | 0.19 | 6H | 24 h | ◯ | 114 |
| Example 7 | | | | | | | | |
| Preparation | 59 | 10 | 0.22 | 0.2 | 4H | 24 h | ◯ | 112 |
| Example 8 | | | | | | | | |
| Preparation | 59 | 1 | 0.23 | 0.23 | 7H | 24 h | ◯ | 113 |
| Example 9 | | | | | | | | |
| Preparation | 59 | 1 | 0.22 | 0.22 | 6H | 24 h | ◯ | 113 |
| Example 10 | | | | | | | | |
| Preparation | 59 | 1 | 0.25 | 0.25 | 5H | 24 h | ◯ | 114 |
| Example 11 | | | | | | | | |

Referring to Table 2, Comparative Preparation Example 1 including a substrate film with no self-healing anti-fingerprinting, shows a high friction coefficient which is unfavorable for a slip property and a low pencil hardness of lower than 3B, and the time of self-healing of scratches is greater than 24 hours. In the marker test, the permanent pen is not completely erased when removing the permanent ink stains, and the water contact angle is too low to provide good water repellent characteristics, so it is understood that Comparative Preparation Example 1 may not have anti-fingerprinting characteristics.

On the other hand, in the cases of Preparation Examples 1 to 11 including the self-healing anti-fingerprinting film according to an embodiment, the friction coefficient is low, e.g., less than or equal to 0.25 or less than or equal to 0.2, to thereby provide a good slip property, the fingerprints are not imprinted (stained) on the surface thereof, and the pencil hardness is greater than or equal to 2H and is even up to 6H or 9H. Also, Preparation Examples 1 to 11 including the self-healing anti-fingerprinting film, are self-healed within 24 hours after being scratched, and a mark from a permanent pen is smoothly removed without being scratched in the marker test, and the water contact angle is greater than or equal to 111 degrees to provide very good water repellent characteristics, so it is confirmed that the fingerprints are not well stained or permanent.

Looking at the effects associated with the POSS amounts, with reference to Comparative Preparation Example 2 and Preparation Examples 1 to 5, it is confirmed that Comparative Preparation Example 2 including the self-healing anti-fingerprinting film having no POSS has a very low pencil hardness of lower than 3B and rarely demonstrates self-healing characteristics. Comparing this, in Preparation Examples 1 to 4, the pencil hardness is higher than or equal to 2H, the scratches are self-healed within 24 hours, and all other properties are excellent. In Preparation Examples 2 to 4 including about 50 wt % to about 70 wt % of POSS, the pencil hardness is very high, e.g., higher than or equal to 5H, and all other properties are excellent. On the other hand, the case of Preparation Example 5 including about 80 wt % of POSS shows that the film is cracked.

Looking at the effects associated with the amount of the fluorinated acryl compound, with references to Comparative Preparation Example 3 and Preparation Example 3 and Preparation Examples 6 to 8, in the case of Comparative Preparation Example 3 including the self-healing anti-fingerprinting film with no fluorinated acryl compound, the friction coefficient is greater than 2.1 which is an unfavorable slip property, the pencil hardness is lower than 3B, and the self-healing characteristics are rarely found. The film of Comparative Preparation Example 3 is scratched by the removal of the permanent pen in the marker test, and the water contact angle is very low, e.g., about 87 degrees, which is unfavorable water repellent, so it is not applicable for an anti-fingerprinting film. On the other hand, in the cases of Preparation Example 3 and Preparation Example 6 to 8, the friction coefficient, the pencil hardness, the self-healing, the marker test, and the water contact angle are evaluated as all excellent. In the cases of Preparation Examples 3, 6, and 7, the pencil hardness is very high as much as greater than or equal to 6H, and the other properties are all excellent.

Looking at the effects associated with the type and amount of polyhedral silsesquioxane, the cases of Preparation Examples 2 to 4 in which phenyl POSS and acryl POSS and fluorinated POSS are mixed and Preparation Examples 9 and 10 in which phenyl POSS and acryl POSS are mixed show very excellent hardness and also show all good characteristics such as the friction coefficient, the water contact angle or the like.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. An anti-fingerprinting composition having a self-healing property, comprising
a polyrotaxane, a polyhedral silsesquioxane, and a fluorinated (meth)acryl compound.

2. The anti-fingerprinting composition of claim 1, wherein the polyrotaxane is a cyclodextrin compound comprising a cyclic molecule, a linear molecule penetrating a ring of the cyclic molecule, and a capping group at each terminal end of the linear molecule,
wherein the cyclic molecule has a curable functional group comprising a (meth)acryl group, a vinyl group, a hydroxy group, a cyanate group, a thiol group, or a combination thereof.

3. The anti-fingerprinting composition of claim 2, wherein the linear molecule comprises polyethylene glycol, polyisoprene, polyisobutylene, polybutadiene, polypropylene glycol, polytetrahydrofuran, polydimethylsiloxane, polyethylene, polypropylene, or a combination thereof.

4. The anti-fingerprinting composition of claim 2, wherein the capping group comprises a dinitrophenyl, a cyclodextrin, an adamantane, a trityl, a fluorescein, a pyrene, a benzene, a polynuclear aromatic, a steroid, or a combination thereof.

5. The anti-fingerprinting composition of claim 1, wherein the polyhedral silsesquioxane is substituted with an alkyl group, an aryl group, a (meth)acryl group, a vinyl group, an amino group, an alcohol group, a carboxyl group, a halogen group, or a combination thereof.

6. The anti-fingerprinting composition of claim 5, wherein the polyhedral silsesquioxane comprises a polyhedral silsesquioxane substituted with a phenyl group, a polyhedral silsesquioxane substituted with a (meth)acryl group, a polyhedral silsesquioxane substituted with a halogen group, or a combination thereof.

7. The anti-fingerprinting composition of claim 1, wherein the fluorinated (meth)acryl compound comprises a cyclic siloxane unit and is a perfluoroether compound having two or more (meth)acryl groups.

8. The anti-fingerprinting composition of claim 1, wherein the anti-fingerprinting composition having the self-healing property further comprises a hardener and a solvent.

9. The anti-fingerprinting composition of claim 8, wherein the polyrotaxane is present in an amount of about 15 weight percent to about 70 weight percent, based on a total solid content of the anti-fingerprinting composition.

10. The anti-fingerprinting composition of claim 8, wherein the polyhedral silsesquioxane is present in an amount of about 25 weight percent to about 80 weight percent based on a total solid content of the anti-fingerprinting composition.

11. The anti-fingerprinting composition of claim 8, wherein the fluorinated (meth)acryl compound is present in an amount of about 0.1 weight percent to about 10 weight percent based on a total solid content of the anti-fingerprinting composition.

12. A self-healing anti-fingerprinting film comprising a cured product of the anti-fingerprinting composition having the self-healing property of claim 1.

13. The self-healing anti-fingerprinting film of claim 12, wherein the self-healing anti-fingerprinting film has a thickness of about 0.01 micrometer to about 50 micrometers.

14. The self-healing anti-fingerprinting film of claim 12, wherein the self-healing anti-fingerprinting film has a friction coefficient of about 0.01 to about 0.5, a pencil hardness of greater than or equal to about 2H, and a water contact angle of about 100 degrees to about 120 degrees.

15. The self-healing anti-fingerprinting film of claim 12, wherein the self-healing anti-fingerprinting film has a light transmittance of greater than or equal to about 80%, a yellowness index of less than or equal to about 3, and a haze of less than or equal to about 3%.

16. A laminate comprising:
a substrate film; and
the self-healing anti-fingerprinting film of claim 12 on at least one surface of the substrate film.

17. The laminate of claim 16, wherein the substrate film is a self-healing film comprising a polyurethane compound, a polysiloxane compound, or a combination thereof.

18. The laminate of claim 16, wherein the substrate film has a thickness of about 10 micrometers to about 300 micrometers.

19. A device comprising the laminate of claim 16.
